(19) United States
(12) Patent Application Publication
(10) Pub. No.: US 2002/0014403 A1
(43) Pub. Date: Feb. 7, 2002

(54) Method of fabricating reflective mask, and methods and apparatus of detecting wet etching end point and inspecting side etching amount

(76) Inventor: Eiichi Hoshino, Kawasaki (JP)

Correspondence Address: STAAS & HALSEY LLP, 700 11TH STREET, NW, SUITE 500, WASHINGTON, DC, 20001, US

(21) Appl. No.: 09/823,757

(22) Filed: Apr. 3, 2001

(30) Foreign Application Priority Data
Aug. 30, 2000 (JP) 2000-260098
Nov. 9, 2000 (JP) 2000-341428
Apr. 7, 2000 (JP) 2000-111908

(51) Int. Cl. H01B 13/00; C23F 1/00; B44C 1/22; C03C 15/00; C03C 25/68

(52) U.S. Cl. 204/192.32; 216/16; 216/57; 216/63; 216/84; 216/109; 204/192.34; 250/200

(57) ABSTRACT

After a Ta radiation absorber 13 is subjected to reactive ion overetching to form a desired pattern till an upper portion of the SiO₂ buffer film 12 is removed, the buffer film 12 is removed by two steps of reactive sputter pre-underetching and final wet etching. In the wet etching, a substrate is rotated while spraying a dilute hydrofluoric acid solution, spray and rotation are ceased, the substrate is illuminated with a light beam to detect regularly reflected light, the detected signal is amplified, differentiated and compared with a reference voltage to detect an etching endpoint, and etching is ceased after a predetermined time has elapsed from the detection of the etching endpoint. At an inspection step, an image of a reflective mask is obtained with a microscope and it is determined that the side etching amount of the buffer film is short if the luminance, at a point of the maximum change rate on a luminance curve around the edge of the Ta radiation absorber 13, is lower than a reference value.

### BACKGROUND OF THE INVENTION

1. Field of the Invention

The present invention relates generally to a method of fabricating a reflective mask for use in transferring a pattern of a semiconductor integrated circuit onto a substrate, and methods and apparatus of detecting wet etching end point and inspecting a side etching amount, more particularly, to a method of fabricating a reflective mask for EUV (Extreme Ultra Violet) lithography, a method and apparatus of detecting wet etching end point using light reflection, and a method and apparatus of inspecting whether or not a side etching amount of a transparent film of a fabricated reflective mask, situated between a absorptive film and a multilayer reflector, is proper.

2. Description of the Related Art

Along with progress in miniaturization of a semiconductor integrated circuit element, EUV lithography of 3 to 30 nm in wavelength has been investigated for improvement on resolution. Almost all transmittable materials have refractive indexes very close to 1 for EUV; therefore, in the exposure apparatus of EUV lithography, instead of refractive lenses, employed is a reduction projection optical system using a reflecting mirror as disclosed in, for example, U.S. Pat. No. 4,747,678. A reflective mask to be employed in such a system is disclosed in, for example, U.S. Pat. Nos. 4,891,830 and 5,052,033.

In reflective mask fabrication, a mask blank is completed in such a way that Mo and a—Si (amorphous silicon) films are alternately stacked on a substrate of glass with a small coefficient of thermal expansion or Si to form a multilayer reflector reflecting nearly 70% of incident EUV radiation in a case where a wave length of EUV is 13.5 nm; an SiO₂ film as a buffer layer is formed on the top a—Si layer of the multilayer; a Ta (tantalum) film as a radiation absorber is formed on the SiO₂ film, and a resist is further coated thereon.

The resist film is selectively exposed to an electron beam according to a desired circuit pattern, followed by developing to form a resist mask.

Using the resist mask, the Ta radiation absorber and the SiO₂ buffer film are selectively etched and then the resist mask is removed.

In the prior art, firstly, the Ta radiation absorber is selectively removed till the SiO₂ buffer film as a stopper film is exposed by means of plasma etching using a chlorine containing gas as a reactive gas.

Then, the SiO₂ buffer film is selectively removed by means of plasma etching using fluorine containing gas as a reactive gas.

Thereafter, the resist mask is removed by means of, for example, plasma ashing to complete a reflective mask.

However, since the top layer of the multilayer reflector is made of a—Si, overetching on the SiO₂ buffer film arises in plasma etching. The buffer film has a thickness of 40 to 50 nm and its underlayer of a—Si has a very small thickness less than 10 nm in order to reduce absorption of EUV radiation, therefore a case arises in which overetching is performed on the subsequently underlying Mo layer, resulting in reducing an EUV radiation reflectance.

On the other hand, if the SiO₂ buffer film is wet etched using, for example, hydrofluoric acid, although the a—Si 11a beneath the buffer film 12 is not removed by etching, side etching is performed on the buffer film to taper it as shown in FIG. 9(B) due to isotropic etching, reducing an area of an effective reflecting region of the multilayer reflector since the bottom edge BE of the sidewall is extruded outside from the bottom edge of the radiation absorber 13. If an etching time is excessively long, the Ta radiation absorber will be inclined. Therefore, regardless of whether the etching time is excessively either short or long, a precision of mask pattern decreases.

In the prior art, a relationship between an etching time and an etching amount was obtained on the bases of observing section shapes of a mask with a scanning electron microscope at predetermined etching time intervals. Therefore, workability was poor and proper etching time was not ensured due to variations in operating conditions. In a technique disclosed in JP 06-13294 A, an Si wafer is irradiated with a laser beam during wet etching in manufacture of a transmission X-ray mask, and when it becomes possible to detect a regularly reflected light by a photodetector, it is determined that the etching have been reached the endpoint since the laser beam is reflected by a back surface of a membrane when the back surface of the membrane is exposed by etching, although almost no reflecting light can enter into the photodetector before the endpoint due to generation of a great number of bubbles caused by a reaction between the Si wafer and etching liquid.

This method, however, cannot be utilized in wet etching on a reflective mask. The reason why is that no bubble is generated during the etching, reflectances of the Ta radiation absorber and the a—Si film 11a are almost same as each other, and further a reflectance of a mask reflective portion is almost constant before and after the etching since the transmittance of the SiO₂ buffer film is close to 1.

In the meantime, it was not possible in the prior art to confirm the side etching amount of the SiO₂ buffer film in a non-destructive way. That is, by cutting a fabricated mask to observe a section thereof with a scanning electron microscope, a side etching amount of the SO₂ buffer film was measured to determine pass or failure.

Although a mask pattern was able to be observed with a vertical illumination type optical microscope having an halogen lamp as a light source, the side etching amount of the SiO₂ buffer film was not able to be confirmed due to a problem of a resolving power limitation.

On the other hand, as disclosed in JP 06-294625 A, there was employed a technique in which an observed image of a mask pattern was analyzed and a signal reflecting the shape of the mask pattern was taken out to recognize the shape. Even with such a prior art method, it is still difficult to discriminate between a side protruding portion of the SiO₂ buffer film and an edge portion of the Ta radiation absorber, and therefore it has not been able to measure the side etching amount of the SiO₂ buffer film in a non-destructive way.

### SUMMARY OF THE INVENTION

Accordingly, it is an object of the present invention to provide a method of fabricating a reflective mask with preventing the bottom edge of a sidewall of a buffer film from being extruded outside from the bottom edge of a radiation absorber film due to side underetching.

It is another object of the present invention to provide a method and apparatus capable of detecting the etching endpoint with a simple configuration even under the conditions that a reflectance is almost constant before and after the etching and no bubble is generated during the etching.

It is still another object of the present invention to provide a method and apparatus capable of simply and surely determining pass or failure of a side etching amount of a transparent film of a reflective mask, situated between a absorptive film and a reflective substrate.

In one aspect of the present invention, there is provided a method of fabricating a reflective mask, comprising the steps of: providing a blank mask, and performing first to third etching.

This blank mask has a buffer film interposed between a radiation absorber film and a multilayer reflector, an etch mask being formed on top of the radiation absorber film, the etch mask having a pattern corresponding to an integrated circuit pattern. The radiation absorber film absorbs, for example, EUV.

In the first etching, reactive ion overetching is performed using a first reactive gas to remove portions of the radiation absorber film together with attaching a first deposit onto sidewalls of portions of the buffer film, the first deposit including a compound formed by reaction of a material of the radiation absorber film with the first reactive gas.

In the second etching, reactive sputter underetching is performed using a second reactive gas to remove portions of the buffer film with leaving a residual buffer film together with attaching a second deposit on sidewalls of portions of the buffer film, the second deposit including a compound formed by reaction of a material of the buffer film with the second reactive gas.

In the third etching, wet etching is performed to remove portions of the residual buffer film using a reactive liquid having a higher solubility of the second deposit than that of the first deposit and to expose portions of a top layer of the multilayer reflector.

With this configuration, since etching liquid takes a longer time to reach the sidewall of the buffer film than the top surface of the buffer film, the sidewall has a relatively steep slope and it can be prevented that the bottom edge of the buffer film is extruded outside from the bottom edge of the radiation absorber film.

In another aspect of the present invention, there is provided a method of detecting a wet etching endpoint, comprising the steps of: providing a substrate, the substrate having a hydrophilic film on a wafer repellent material; applying an etching aqueous solution film on the hydrophilic film; illuminating the substrate with a light beam; and detecting the wet etching endpoint on the bases of a disturbance of reflected light from the substrate.

When the underlying material is exposed by etching, the etching aqueous solution is transformed into particles since the etching aqueous solution is a film, the underlying material is water-repellent and the etching aqueous solution has a surface tension, and thereby disturbances occurs in intensity of reflected light. Therefore, the etching endpoint can be detected based on the disturbance of reflected light from the substrate with a simple configuration even if a reflectance is almost constant before and after the etching and no bubble is generated through a chemical reaction with the etching liquid.

In another aspect of the present invention, there is provided a method of inspecting a reflective mask, comprising the step of: providing a microscope picking up a magnified image data of the reflective mask; obtaining a luminance curve on a line extending from a portion of a absorptive film to a portion of a reflective substrate using the image data; obtaining a luminance at a point where a luminance change rate on the luminance curve is about maximum as a characteristic luminance; and determining whether or not an extruding length of a bottom edge of a sidewall of the transparent film outside from a bottom edge of the absorptive film is longer than a maximum permissible length on the basis of the characteristic luminance.

With this configuration, it is possible to simply and surely determine pass or failure of a side etching amount of the transparent film of the reflective mask, situated between the absorptive film and the reflective substrate even if it is not possible to determine directly from the picked-up image due to the deficient resolving power of the microscope.

Other aspects, objects, and the advantages of the present invention will become apparent from the following detailed description taken in connection with the accompanying drawings.

### BRIEF DESCRIPTION OF THE DRAWINGS

FIGS. 1(A) to 1(C) are illustrative sectional views of characteristic portions of a first embodiment according to the present invention, FIG. 1(A) is a view of a state in which a radiation absorber 13 has been subjected to reactive ion overetching in fabrication process of a reflective mask, FIG. 1(B) is an enlarged detailed view of a portion 1B of FIG. 1(A) and FIG. 1(C) is a view of a state in which an SiO₂ buffer film 12 has been subjected to reactive sputter underetching from the state of FIG. 1(B).

FIG. 2 is a graph showing experimental results on an etching time vs. an etching depth in cases where the SiO₂ buffer film is covered by a deposit film 15 as shown in FIG. 1(B) and the SiO₂ buffer film is covered by a deposit film 16 as shown in FIG. 1(C) are etched with dilute hydrofluoric acid solution of a 3.3% concentration.

FIG. 3(A) is a schematic sectional view of a mask blank, and FIG. 3(B) is a schematic sectional view of a state in which a resist mask is formed on the mask blank of FIG. 3(A).

FIG. 4(A) is a schematic sectional view of a state in which the SiO₂ buffer film 12 has been subjected to reactive sputter under-etching from the state of FIG. 1(A), and FIG. 4(B) is a schematic sectional view of a state in which the residual SiO₂ buffer film 12 has been subjected to just wet etching from the state of FIG. 4(A).

FIG. 5 is a schematic sectional view of a state in which the resist mask 14 has been removed from the state of FIG. 4(B).

FIGS. 6(A) to 6(D) and FIGS. 7(E) to 7(H) are schematic sectional views showing a process of fabricating a reflective mask of a second embodiment according to the present invention.

FIG. 8 is a graph showing experimental results on the concentration of hydrofluoric acid vs. the etching depth of SiO₂ in a case where a dipping time is 10 sec.

FIGS. 9(A) and 9(B) are illustrative sectional views showing the top edge position TE and the bottom edge position BE of the SiO₂ buffer film 12 tapered by side etching, relative to the bottom edge of the radiation absorber 13.

FIG. 10 is a graph showing experimental results on a wet etching time vs. an extruded bottom edge position X of the SiO₂ buffer film 12 subjected to reactive sputter under-etching, outside from the bottom edge of the radiation absorber.

FIG. 11 is a schematic diagram showing a wet etching apparatus of a third embodiment according to the present invention.

FIGS. 12(A) and 12(B) are both diagrams showing embodiments of the etching endpoint determining circuit of FIG. 11.

FIG. 13 is a general flow chart showing a control by the control circuit of FIG. 11.

FIG. 14 is a waveform graph showing a change in a voltage signal VIA of FIG. 12(A) with elapse of an etching time.

FIGS. 15(A) to 15(D) are illustrations of states at four different times, respectively, on the graph of FIG. 14.

FIG. 16 is a schematic block diagram showing a side etching amount pass/failure determining apparatus of a fourth embodiment according to the present invention.

FIG. 17 is a picture taken with the microscope of FIG. 16.

FIG. 18 is a graph showing a luminance curve along an X direction in the inspection region 72 of FIG. 16.

FIG. 19 is a graph showing a relationship between a characteristic luminance CL of FIG. 18 and a length D from the bottom edge of a Ta radiation absorber to the outside extruded bottom edge of the SiO₂ buffer film.

FIG. 20 is an illustration of a reflection intensity near a boundary between the Ta radiation absorber and a multilayer reflector.

FIG. 21 is a flow chart showing a procedure of pass/failure determination of a side etching amount, of a fifth embodiment according to the present invention.

### DESCRIPTION OF THE PREFERRED EMBODIMENTS

Referring now to the drawings, wherein like reference characters designate like or corresponding parts throughout several views, preferred embodiments of the present invention are described below.

First Embodiment

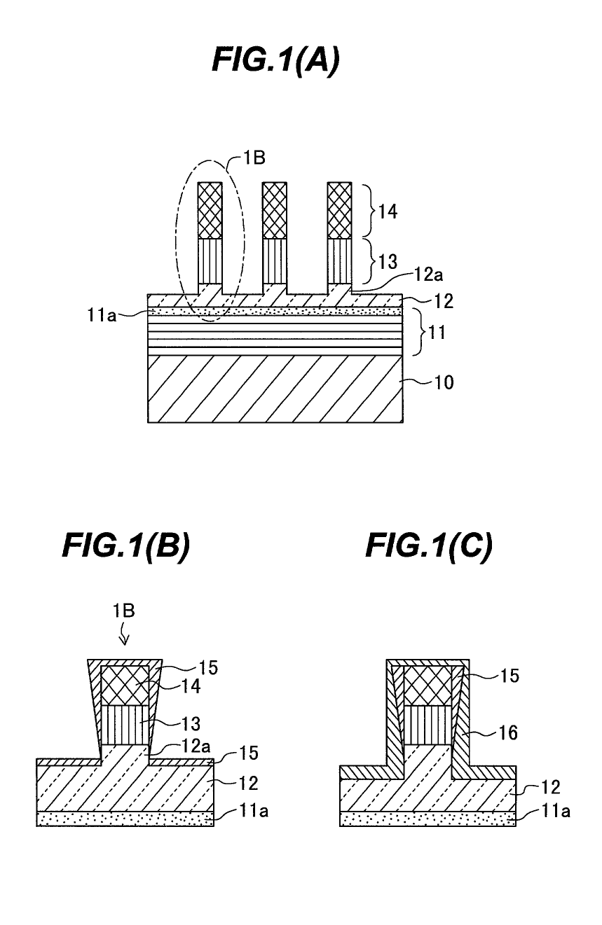

Referring to FIGS. 1(A) to 1(C), a method of fabricating a reflective mask of a first embodiment according to the present invention is shown.

This method is characterized by that after a radiation absorber 13 is overetched by reactive ions to remove it and upper portion of a buffer film 12, the remaining buffer film 12 is fully removed by two steps of reactive sputter pre-etching and successive wet etching. That is, at the first step, reactive sputter underetching is performed for the SiO₂ buffer film 12 without exposing an underlying a—Si (amorphous silicon) layer 11a as shown in FIG. 1(C), and at the second step, the remaining buffer film 12 is removed with a dilute hydrofluoric acid solution.

Next, this method will be detailed.

The Ta radiation absorber 13 is subjected to reactive ion etching using a chlorine while a deposit film 15 of materials such as a chloride of Ta is, as shown in FIG. 1(B) which is an enlarged portion 1B of FIG. 1(A), is formed as if protecting a pattern sidewall, and thereby anisotropic etching is performed. Successively, an upper portion of the SiO₂ buffer film 12 is etched while the deposit film 15 is likewise formed on the surface thereof.

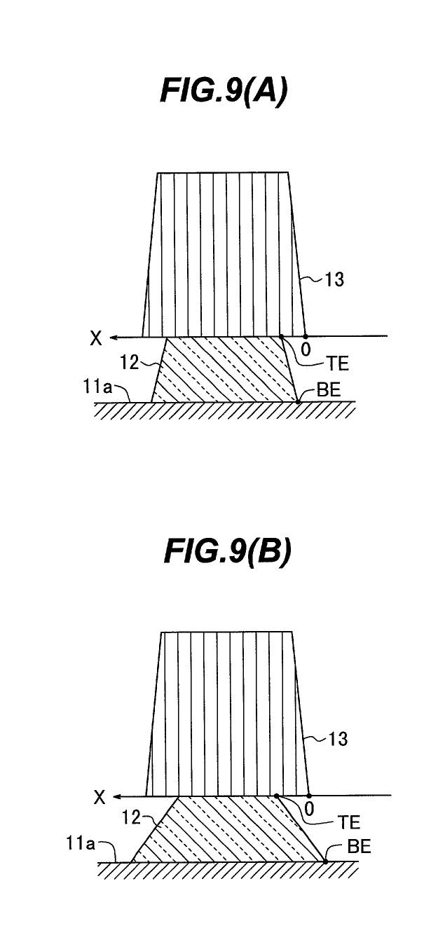

In this state, if a dilute hydrofluoric acid solution were forced to act as etching liquid for the SiO₂ buffer film, an etching speed would be slowed since the deposit film 15 is mainly the chloride of Ta and the dilute hydrofluoric acid solution is hard to penetrate it to reach the SiO₂ buffer film 12. In this case, since etching speeds in the vertical and horizontal directions are equal, the etched SiO₂ buffer film 12 would be tapered as shown in FIG. 9(B).

In order to avoid such a phenomenon, for the state of FIG. 1(B), reactive sputter underetching is performed with using a fluorine containing gas as a reactive gas to reach a state shown in FIG. 1(C). In this etching, not only is a deposit film 16 containing carbon and fluorinated carbon is formed on a sidewall of the pattern, but also an upper portion of the SiO₂ buffer film 12 is removed. The deposit film 15 formed on the top surface of the SiO₂ buffer film 12 is sputter-etched off, but the deposit film 15 formed on the sidewall is left behind by a sidewall protection effect of a fluorine containing gas plasma.

When a dilute hydrofluoric acid solution is applied as etching liquid for this state, progress in etching on the sidewall near a boundary between the radiation absorber 13 and the convex portion 12a of the buffer film 12 is slowed since the deposit film 15 is left there, which forces the etching liquid to reach the convex portion 12a in a longer time. In contrast to this, the top surface of the buffer film 12 is covered with the deposit film 16 containing carbon and fluorinated carbon, and therefore progress in etching of the buffer film 12 is faster relative to the sidewall of the convex portion 12a.

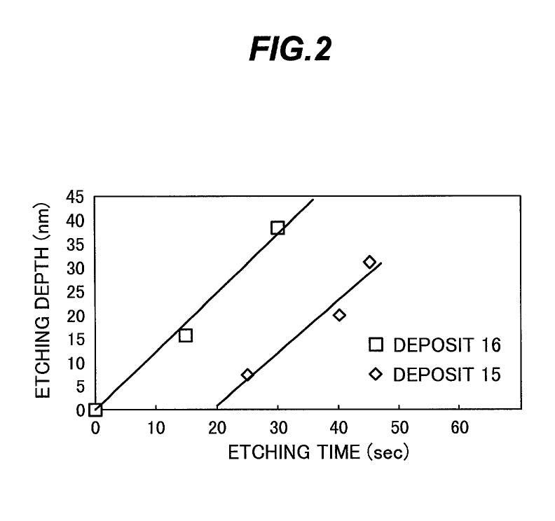

FIG. 2 is a graph showing experimental results on an etching time vs. an etching depth in cases where a first and a second SiO₂ buffer films covered only with the deposits films 15 and 16, respectively, are wet etched with a 3.3% concentration dilute hydrofluoric acid solution.

It is found from FIG. 2 that when covered with the deposit film 15, an etching start time point of the SiO₂ buffer film 12 is delayed, and more of time is required in order to obtain the same etching depth.

For such a reason, the residual SiO₂ buffer film can be removed with a dilute hydrofluoric acid solution with leaving a tapered convex portion having a steep slope, whereby it can be prevented that the bottom edge of the SiO₂ buffer film is extruded a long distance outside from the bottom edge of the radiation absorber, resulting in preventing a reflectance of EUV radiation near the sidewall of the etched SiO₂ buffer film from reducing.

Next, description will be given of a more detailed embodiment of a method of fabricating a reflective mask.

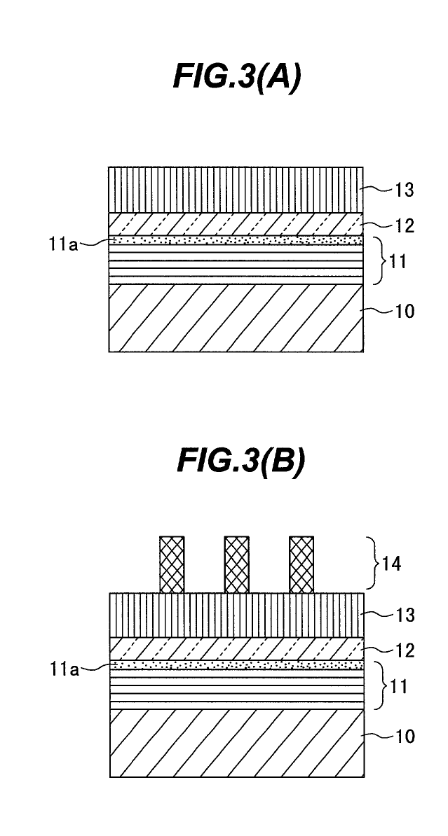

(1) Preparation of a mask blank (FIG. 3(A))

In order to form a multilayer reflector 11 as an EUV radiation reflector, 40 pair layers of Mo and a—Si films with 6.9 nm in cycle length were stacked on an Si wafer substrate 10 of 6 inch in diameter, except that the top layer as a protective film was an a—Si 11a of 8 nm in thickness. On the a—Si film 11a, an SiO₂ film 12 as a buffer film was formed up to 40 nm in thickness by means of an RF magnetron sputtering method. In addition, a Ta film 13 as a radiation absorber was formed up to 100 nm in thickness by means of a DC magnetron sputtering method. Since a crystal structure of Ta is a column-shaped, by sputtering, Ta particles penetrated 1 nm or less into the underlying SiO₂ buffer film 12 to form a mixed layer.

(2) Formation of a resist mask 14 (FIG. 3(B))

In order to form a resist mask on the radiation absorber 13, a resist of ZEP 7000 from Nippon Zeon Company was applied on the radiation absorber 13 up to 330 nm in thickness by the spin coating method, and the resist was subjected to baking on hot plate at 150° C. for 3 minutes. Then, a latent image of a desired pattern was written onto the resist by the electron beam exposure method. Thereafter, the pattern was developed by the spin developing method with using a developing liquid of ZED 500 from Nippon Zeon Company and a rinse liquid of methyl isobutyl ketone.

(3) Reactive ion overetching for the radiation absorber 13 (FIG. 1(A) and 1(B))

The Ta radiation absorber 13 was subjected to reactive ion etching till the top surface of the SiO₂ buffer film 12 as a stopper film had been fully exposed with using a reactive mixed gas composed of Cl₂ gas at 20.0 ml/min and BCl₃ gas at 80.0 ml/min under a pressure of 0.5 Pa. Microwave power was 600 W and RF power was 30 W. An etching time was set such that the Ta radiation absorber 13 could be etched off up to 150% of the actual thickness thereof.

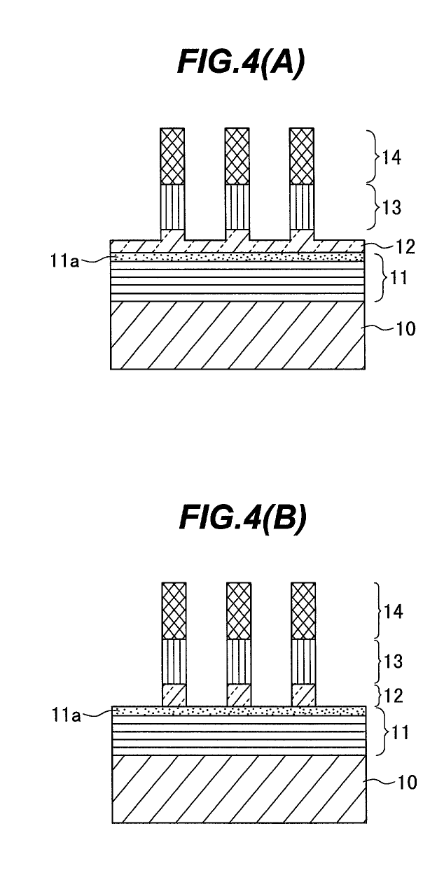

(4) Reactive sputter pre-underetching for the SiO₂ buffer film 12 (FIG. 4(A))

The SiO₂ buffer film 12 was subjected to sufficient reactive sputter underetching to an extent at which no surface of the a—Si film 11a was exposed with using a reactive mixed gas composed of Ar gas at 200.0 ml/min, C₄F₈ gas at 10.0 ml/min and O₂ gas at 20.0 ml/min under a pressure of 1.0 Pa. Microwave power was 400 W and RF power was 15W. It is preferable in order to assure a uniform wet etching rate to be next performed that this etching depth is at least such one that all the Ga stain generated by applying a FIB (focused ion beam), which is explained later, can be removed.

(5) Wet etching for the residual SiO₂ buffer film 12 (FIG. 4(B))

A relationship of the concentration of hydrofluoric acid (HF) vs. an etching rate was investigated in order to determine an etching time for the SiO₂ buffer film 12.

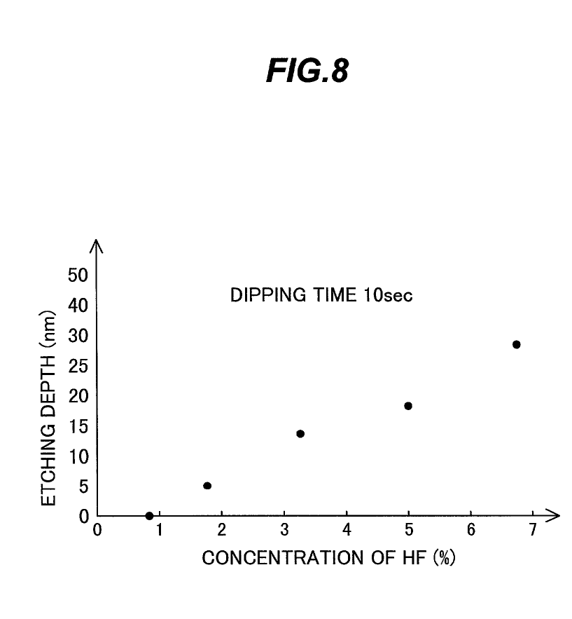

FIG. 8 is a graph showing experimental results on a concentration of hydrofluoric acid vs. an etching depth of SiO₂ in a case where a dipping time is 10 seconds.

The hydrofluoric acid concentration was determined at 3.3% from FIG. 8 because relatively good etching control is attained when the SiO₂ buffer film of 40 nm in thickness is etched in a time period of several tens of seconds.

When the residual film thickness of the SiO₂ buffer film 12 was 4.6 nm, by dipping the substrate in a 3.3% concentration solution of hydrofluoric acid for 30 sec, a good pattern shape of the etched SiO₂ buffer film 12 whose taper caused by side etching had a steep slope was obtained.

In regard to a direction parallel to the substrate, the etched shapes of the radiation absorber 13 and the SiO₂ buffer film 12 becomes as shown in FIG. 9(A) due to side etching. In order to express a side etching amount, assume an X axis which is parallel to the substrate, has an origin at the bottom edge of the radiation absorber 13 and has a direction toward the interior from the origin. Positions TE and BE denote the top and the bottom edges of the SiO₂ buffer film 12, respectively, and D=−BE is an extruded length of the bottom edge BE outside from the origin of the X axis. Regarding X coordinate, FIG. 9(A) shows a case where TE>BE>0 and FIG. 9(B) shows a case where TE>0>BE.

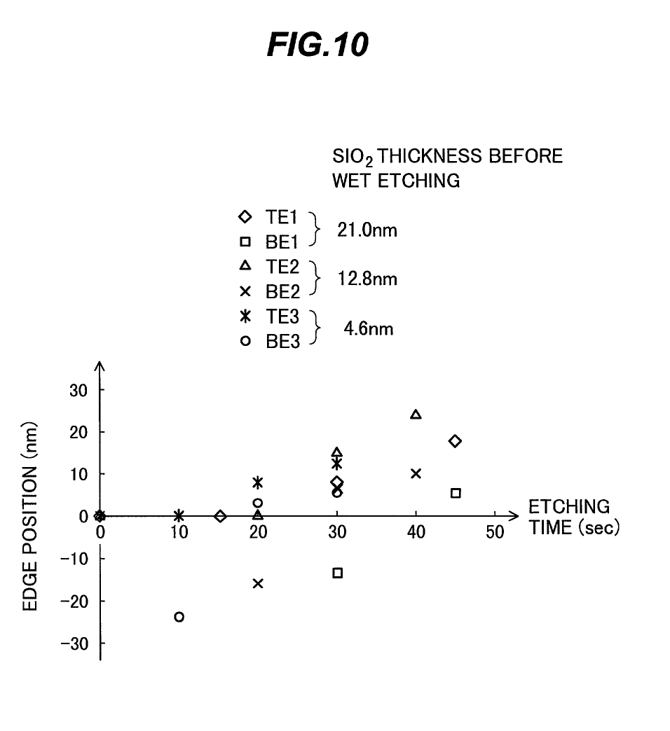

FIG. 10 is a graph showing experimental results on an etching time vs. an edge position X of the SiO₂ buffer film 12, wherein top edge positions TE1 to TE3 and bottom edge positions BE1 to BE3 of SiO₂ buffer films after the above-described wet etching had been performed starting from their thicknesses of 21.0 nm, 12.8 nm and 4.6 nm, respectively, by the above-described dry etching.

It is clear from FIG. 10 that when the wet etching time is fixed at 30 sec, the bottom edge position BE is about 5 nm for any of the thicknesses of 12.8 nm and 4.6 nm of SiO₂ buffer films to be etched.

Therefore, if the thickness target value of the thickness of the SiO₂ buffer film prior to the wet etching is (12.8+4.6)/2=8.7 nm, the bottom edge position BE can be made at about 5 nm even if the thickness thereof varies +/−4.1 nm.

If the film formation thickness error of the SiO₂ buffer film 12 of 40 nm thick is +/−2 nm and if the dry etching error of the SiO₂ buffer film 12 is +/−2 nm after the Ta radiation absorber 13 is overetched, the sum of both errors is within +/−4.1 nm described above. This dry etching error corresponds to about +/−7.6% of the dry etching amount (35−8.7=26.3 nm) of the SiO₂ buffer film 12. This can be sufficiently realized with a plasma etching apparatus available on the market.

In general, in order to attain a good pattern shape of the SiO₂ buffer film 12 with a steeply sloped sidewall caused by side etching, it has been found that when the concentration of hydrofluoric acid is 3.3%, the wet etching time has only to be determined to be the sum of a time t1 for just etching the thickness of the residual SiO₂ buffer film 12 and a time t2 less than t1.

Note that since the resist of ZEP 7000 used as the resist mask is dissolved in hydrofluoric acid, there arises a need for continuously providing fresh etching liquid to a mask on fabrication in order to prevent dissolved resist from exerting an adverse influence on an etching rate. For this reason, a spray or a paddle type wet etching apparatus is desirably employed.

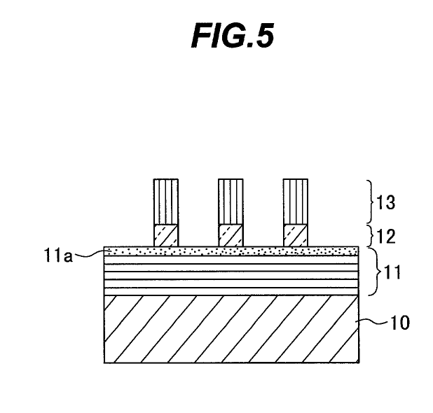

(6) Removal of the resist mask 14 (FIG. 5)

Finally, the residual resist mask 14 was subjected to plasma ashing with a reactive gas composed of Ar and O₂ to be removed off.

Second Embodiment

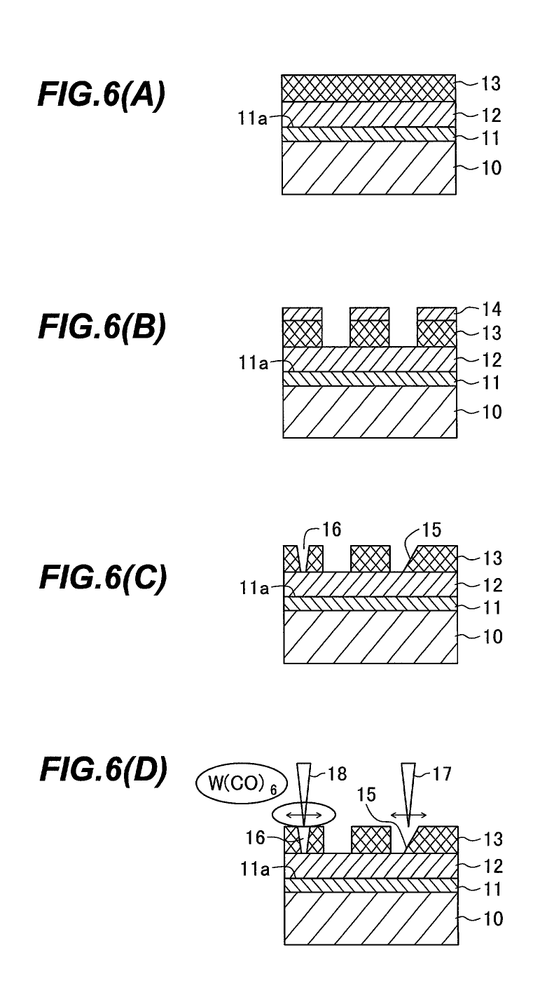

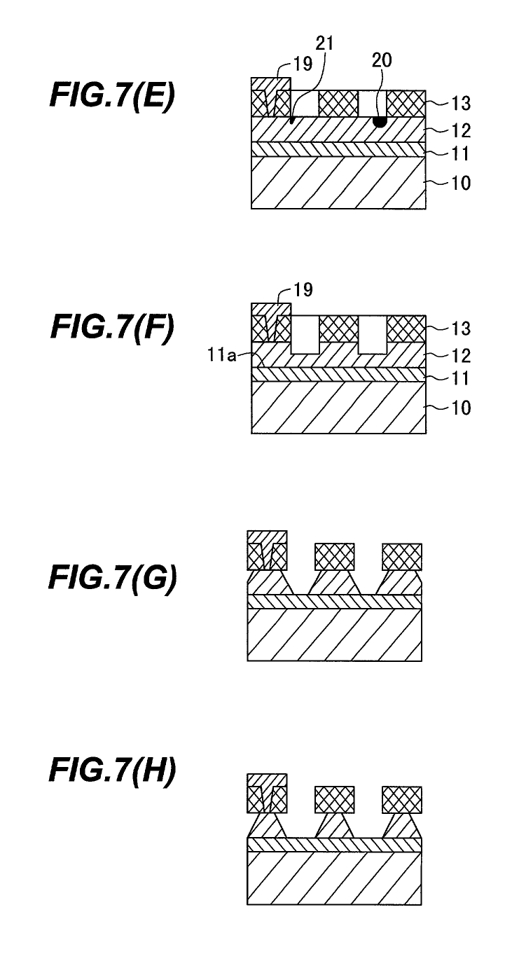

Referring to FIGS. 6(A) to 6(D) and FIGS. 7(E) to 7(H), there is shown a fabrication process of a reflective mask of a second embodiment according to the present invention. In these FIGS., sections of a multilayer reflector 11 are simplified.

(A) To obtain a mask blank, there is formed a multilayer reflector 11 in which low and high refractive index films such as a Mo and an a—Si films are alternately stacked on a substrate 10 whose material is an Si or one having a low coefficient of heat expansion such as a glass. A radiation absorber film 13 such as a Ta is formed through a buffer film 12 such as an SiO₂ film on the top layer of the multilayer reflector 11 such as a—Si film 11a. When the wavelength of EUV is 13.5 nm, the reflectance of the multilayer reflector 11 can be about 70%.

(B) In order to form a resist mask pattern of a desired circuit on the mask blank, a resist 14 is applied thereon, a latent image is written on the resist with using an exposure system such as an electron beam exposure system, and developing is performed. Then, the radiation absorber 13 is etched by means of plasma etching having a high selectivity ratio of the radiation absorber 13 to the underlying buffer film 12. For example, when the radiation absorber 13 is of Ta, chlorine containing gas plasma can be used. Then the resist mask is removed by plasma ashing or other means.

(C) It is inspected whether or not selective etching on the radiation absorber 13 has been performed without error.

(D) If a residue 15 of the radiation absorber 13 exists, it is removed by local etching. For example, the residue 15 is irradiate by a Ga ion beam 17 from a FIB (focused ion beam) apparatus to remove the residue 15. Further, if a defective void 16 exists in the radiation absorber 13, it is filled with absorbing material. For example, the defective void 16 is filled with W metal by irradiating a Ga ion beam in an atmosphere of W(CO)₆.

(E) Since the Ga ion beam penetrates about 30 nm into the SiO₂ buffer film 12, Ga stains 20 and 21 are generated. The SiO₂ buffer film 12 prevents the Ga stains from penetrating into the multilayer reflector 11.

(F) The buffer film 12 is underetched by gas plasma with the etched radiation absorber 13 as a resist mask. For example, when the radiation absorber 13 is of Ta and the buffer film 12 is of SiO₂, fluorine containing gas plasma can be used. By this underetching, the Ga stains 20 and 21 are removed.

(G and H) Then, to remove the residual buffer film 12 completely, the reflective mask of FIG. 7(F) is dipped into an etching liquid having a high selectivity ratio of the residual buffer film 12 to the top layer of the multilayer reflector 11. For example, a dilute hydrofluoric acid solution can be used as etching liquid when the buffer film 12 is of SiO₂ and the top layer of the multilayer reflector 11 is of a—Si.

Although the wet etching is performed in this second embodiment after removing the resist, this removing may be performed after step H as described in the first embodiment.

Third Embodiment

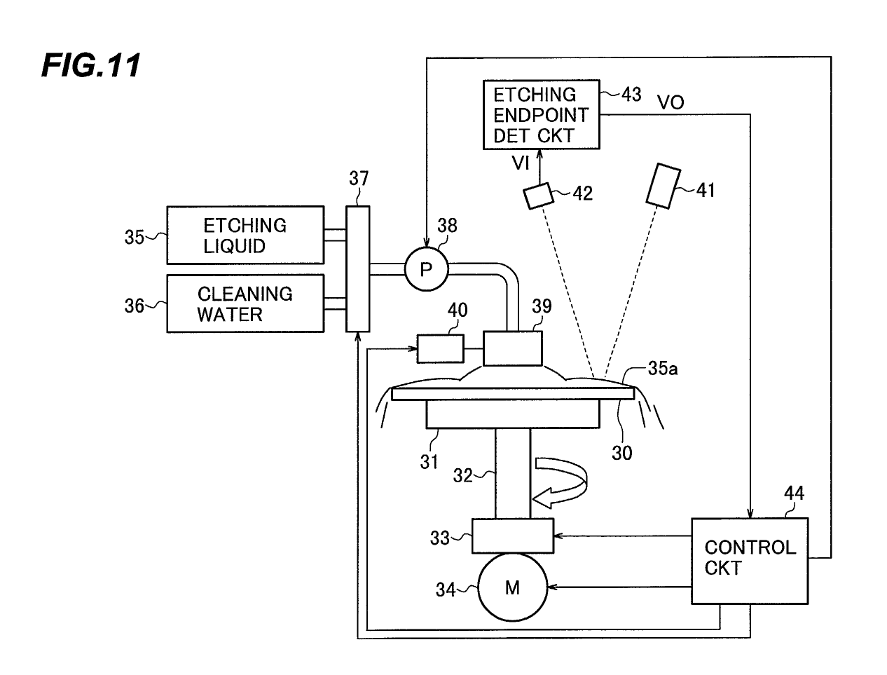

Referring now to FIG. 11, there is shown a wet etching apparatus of a third embodiment according to the present invention.

A substrate 30 to be etched is one shown in FIG. 7(F) for example. It is important in this embodiment that a target material to be etched is hydrophilic and the underlying layer is water repellent, as shown in FIG. 7(F) for example, the SiO₂ buffer film 12 is a target material to be etched and the a—Si film 11a of the top layer of the multilayer reflector 11 is the underlying layer.

The substrate 30 is vacuum-chucked on a rotary table 31. The rotary table 31 is rotated by a motor 34 through a rotary shaft 32 and a transmission 33.

On the other hand, one of an etching liquid 35 and a cleaning water is selectively provided to the inlet of a pump 38 through a selector valve 37. The outlet of the pump 38 is connected to a nozzle 39 through a pipe. The nozzle 39 can be adjustably moved relatively to the substrate 30 in a vertical direction by an actuator 40. A light source 41 is disposed such that a light beam obliquely comes onto the top surface of the substrate. A photodetector 42 is disposed so as to detect the light beam reflected regularly on the substrate 30. The output signal VI of the photodetector 42 is provided to an etching endpoint determining circuit 43.

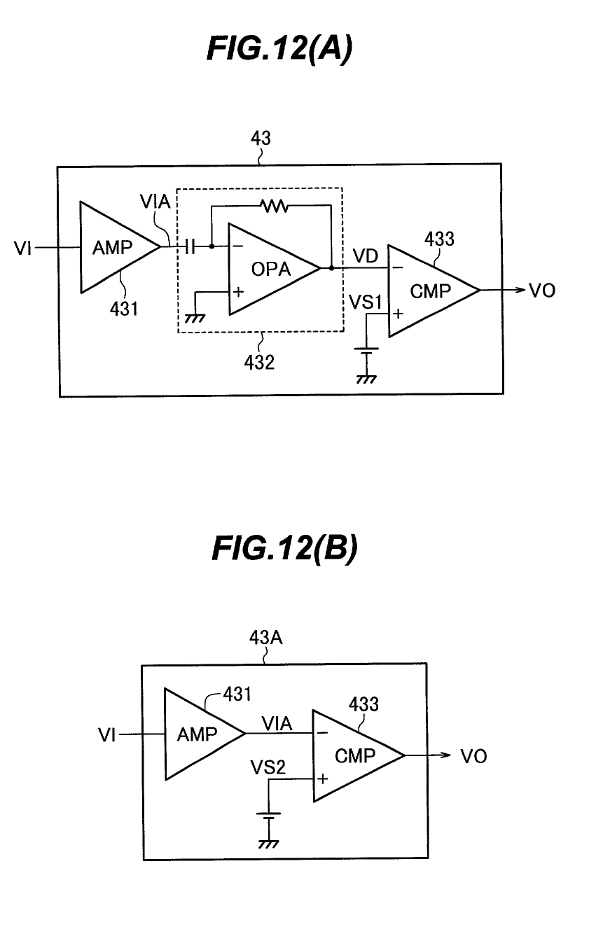

FIG. 12(A) shows an embodiment of the etching endpoint determining circuit 43.

In this circuit, the incoming signal VI is amplified by an amplifier 431 and the output signal VIA thereof is provided through a differentiator 432 having an operational amplifier to the inverting input of a comparator 433 as a signal VD. To the non-inverting input of the comparator 433, provided is a reference voltage VS1. When VD>VS1, the output VO of the comparator 433 is low.

Referring back to FIG. 11, the etching endpoint detection signal VO of the circuit 43 is provided to a control circuit 44. The control circuit 44 controls the transmission 33, the motor 34, the selector valve 37, the pump 38 and the actuator 40.

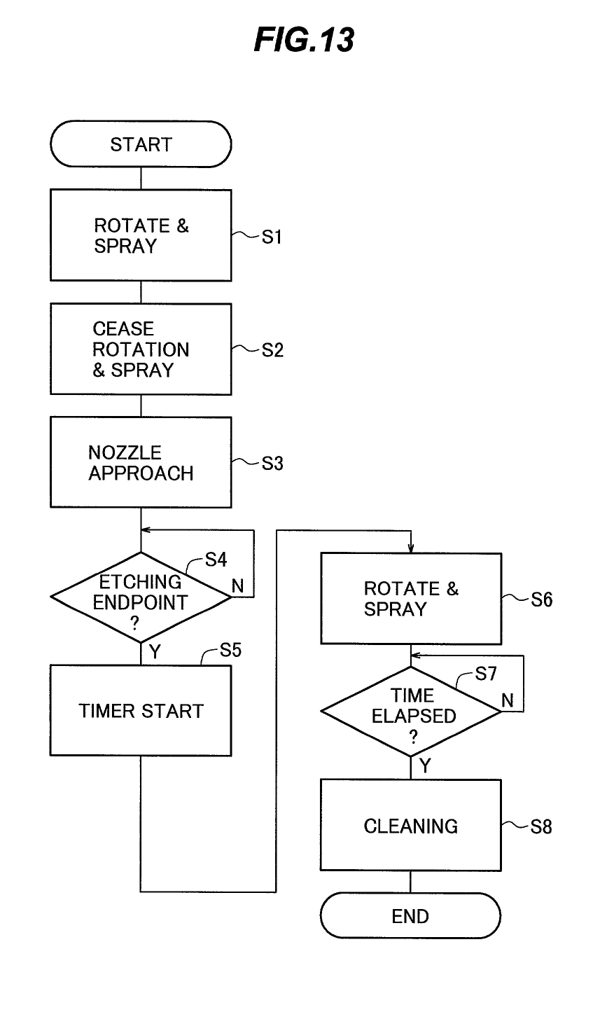

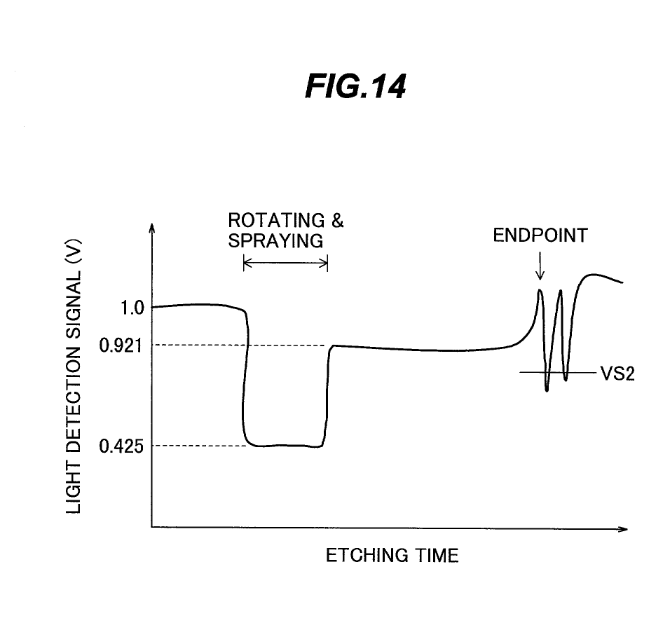

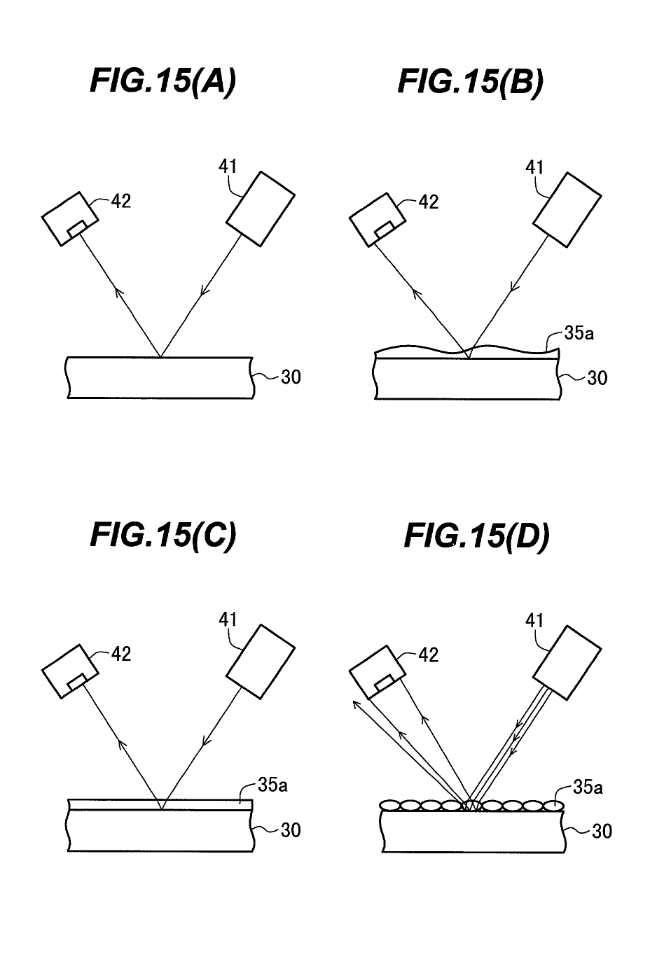

FIG. 13 is a general flow chart showing control by the control circuit 44. FIG. 14 shows a change in the voltage signal VIA of FIG. 12(A) with elapse of an etching time. FIGS. 15(A) to 15(D) are illustrations for explaining the graph of FIG. 14.

Next, description will be given of control of the control circuit 44 in relation to an actual example.

The substrate 30 having a structure as shown in FIG. 7(F) was used. The Ta radiation absorber 13 also serves as a resist mask for an SiO₂ buffer film 12. Under normal conditions, the reflectance distribution of the substrate 30 is almost constant before and after etching since the reflectances of the Ta radiation absorber 13 and the a—Si film 11a are very small and roughly the same as each other and the transmittance of the SiO₂ buffer film 12 is close to 1. As etching liquid 35, a dilute hydrofluoric acid aqueous solution of 3.3% concentration was employed, as a light source 41 a He—Ne laser with an output power of 5 mW, as a photodetector an a—Si solar cell, and as the rotary table 31 an SFE-3000 from Sigma Meltech Company. A diameter of a light beam was several mm.

The following pretreatment was performed prior to the step S1 of FIG. 13. That is, mounting angles of the light source 41 and the photodetector 42 was adjusted as shown in FIG. 15(A) such that the output of the photodetector 42 was maximized. The amplification factor of the amplifier circuit 431 was adjusted such that the signal VIA of FIG. 12(A) was 1V. The substrate 30 was vacuum-chucked. The transmission 33 was switched such that the rotation speed of the rotary table 31 would be at 50 rpm when turned on. The gap between the nozzle 39 and the substrate 30 was adjusted to be 5 mm.

(S1) The control circuit 44 selected the etching liquid 35 with the selector valve 37, turned the motor 34 and the pump 38 on to rotate the substrate, and at the same time caused etching liquid 35a to be sprayed from the nozzle 39. The signal VIA fell down to 0.425 V as shown in FIG. 14 since the surface of the etching liquid 35a waved as shown in FIG. 15(B).

(S2) The control circuit 44 turned the motor 34 and the pump 38 off after a predetermined time had elapsed to cease rotation of the substrate 30 and spray of the etching liquid 35a. Thereby the state became as shown in FIG. 15(C), and the signal VIA rose up to 0.921 V as shown in FIG. 14.

(S3) The control circuit 44 forced the nozzle 39 to approach a substrate 30 side through the actuator 40 to adjust a gap between the nozzle 39 and the substrate 30 to 3.5 mm.

(S4) When etching had progressed and the underlying a—Si was exposed, the shape of the etching liquid changed from a film into a plurality of particles as shown in FIG. 15(D) by the operations of water repellency of a—Si and surface tension of the etching liquid 35a, whereby a light amount into the photodetector was disturbed and the signal VIA was vibrated as shown in FIG. 14. At this time, a relation of VD>VS1 was established, and the endpoint determination signal VO changed to low to indicate the etching endpoint.

The reason why the signal VIA temporarily rose to values higher than a steady-state voltage of 0.921 V in the signal vibration is that there arise cases where etching liquid particles functions as a convex lens to condense reflected light into the photodetector 42.

Because of isotropic etching, the etched SiO₂ buffer film 12 has a tapered shape as shown in FIG. 9(B) at the etching endpoint.

(S5) The control circuit 44 started an internal timer in response to the fall of the signal VO.

Preferably the timer has a setting time to be needed to change from the state of FIG. 9(B) to the state of FIG. 9(A) in which the bottom edge BE of the SiO₂ buffer film 12 is approximately positioned directly under the bottom edge of the Ta radiation absorber 13, which is determined from experience and is a value in the range 10 to 20 sec.

If this time is excessively short, the substantial reflecting region of the multilayer reflector 11 decreases, and if being excessively long, the Ta radiation absorber may slant, and therefore a mask pattern precision is reduced in either of both cases.

(S6) The control circuit 44 turned the motor 34 and the pump 38 on to rotate the substrate 30 at a 50 rpm, and forced the etching liquid 35a to be sprayed over the substrate 30. Etching liquid film contact on the SiO₂ buffer film 12 could be prevented from breaking due to water repellent since rotation of the substrate 30 and spray of the etching liquid 35a was performed under the condition that the nozzle 39 was positioned close to the substrate 30.

(S7) The timer awaited time-up.

(S8) The control circuit 44 switched over the selector valve 37 to the cleaning water 36, and also switched over the transmission 33 to rotate the rotary table 31 at 250 rpm. With this, cleaning was performed on the substrate 30 and the etching was completed, whereby a state as shown in FIG. 9(A) was brought up.

According to the third embodiment, the etching endpoint can be automatically and correctly determined with a simple configuration, whereby a side etching time is optimized, and in addition to this, by the prevention of etching liquid film breakage, a high precision mask pattern can be attained.

Fourth Embodiment

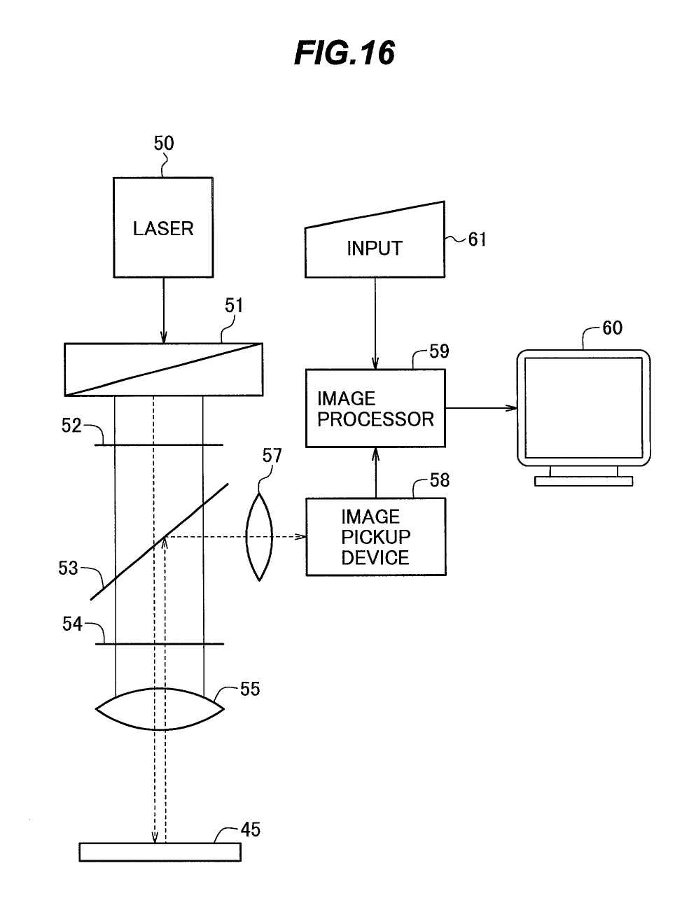

Referring now to FIG. 16, there is shown a side etching amount pass/failure determining apparatus of a fourth embodiment according to the present invention.

A laser 50 is, for example, a neodymium YAG laser of 266 nm in wavelength, and emits a linearly polarized light beam. The light beam is subjected to raster scan by an acoustooptic deflector 51, and passes through a neutral density (ND) filter 52. The ND filter 52 is used for attenuating an excessively strong laser beam. A polarization beam splitter 53 is located under the ND filter 52 such that the whole incoming laser beam passes through the polarization beam splitter 53. The laser beam passed through the polarization beam splitter 53 passes through a ¼ wave length plate 54 to be transformed into circularly polarized light, and then passes through an objective lens 55 to be condensed on a reflective mask 45. Light reflected by the reflective mask 45 passes through the objective lens 55 to be collimated, and then passes through the ¼ wave length plate 54 to be converted into linearly polarized light. This linearly polarized light is totally reflected by the polarization beam splitter 53, and then passes through an imaging lens 57 to be condensed on to an image pickup device 58. Thus the light spot on the image pickup device 58 is subjected to raster scan thereon. The video signal output from the image pickup device 58 is provided to an image processor 59 to process the image, and its result and the picked-up image are displayed on the screen of a display device 60.

The extruded length D of the SiO₂ buffer film is a value in the range 10 to 20 nm at the most, and therefore cannot be determined directly from the picked-up image due to a deficient resolving power.

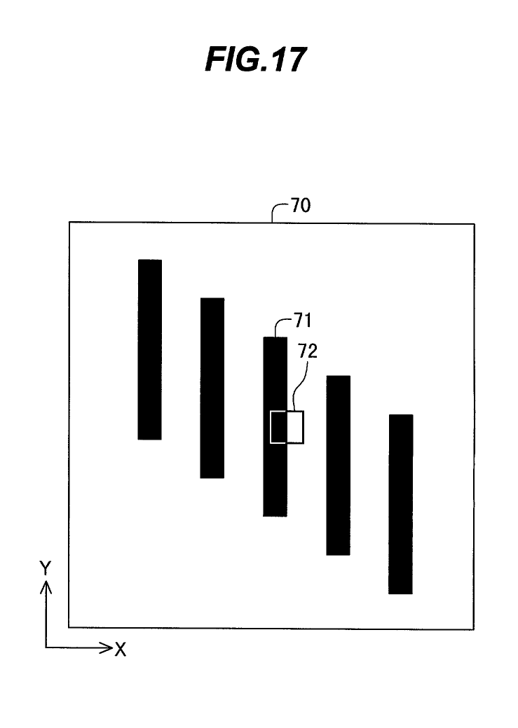

FIG. 17 shows a picked-up image of a test reflective mask 45 taken with the microscope of FIG. 16.

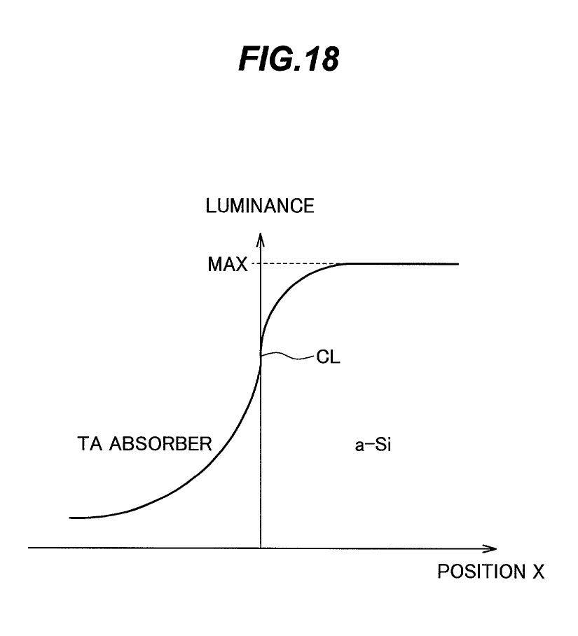

Five black bands corresponding to the Ta radiation absorber 13 exist in the view field of 20 mm×20 mm. An operator operates an input device 61 of FIG. 16 to specify an inspection region 72 as shown in FIG. 17 to the image processor 59. The region 72 is a rectangular including both sides of an edge line of a black band 71, one side being a dark portion of the Ta radiation absorber 13 and the other side a bright portion of the multilayer reflector 11. The image processor 59 obtains a luminance of each pixel point on the X axis in the inspection region 72 as a value obtained by accumulating pixel values on a pixel line parallel with the Y axis for higher precision to obtain a luminance curve as shown in FIG. 18. Then a position on X axis is determined at which a change rate of the luminance curve is maximum, and if the luminance (characteristic luminance CL) at this point is less than a reference value, it is determined that side etching is insufficient.

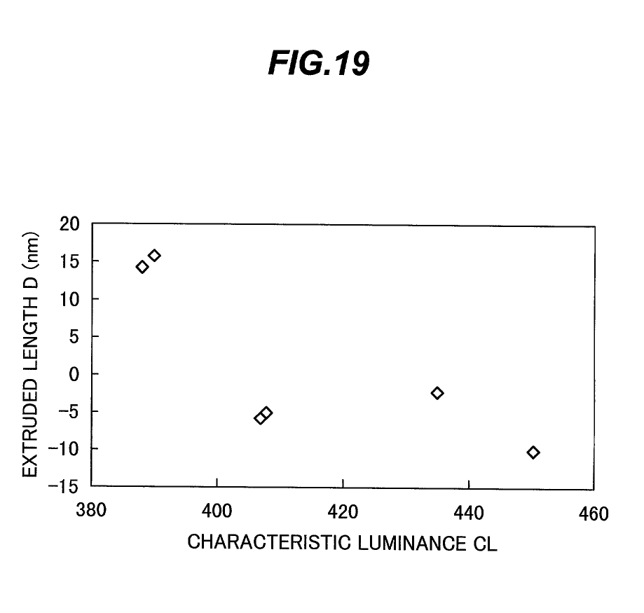

FIG. 19 shows a relationship between actually measured values of (CL, D). The extruded length D of the bottom edge BE outside from the origin of the X axis in FIG. 9(B) is a value obtained by observing a corresponding section of a reflective mask 45 with a scanning electron microscope. It is clear from FIG. 19 that when D<0, the characteristic luminance CL is larger than a certain value. That is, if the characteristic value CL is larger than a predetermined value, it can be determined that a side etching amount is good.

The reason why it can be determined whether or not a side etching amount is good in such a non-destructive way would be considered as follows:

(1) there are differences in reflectance among the a—Si film 11a, the Ta radiation absorber 13 and the side protruding portion of the SiO₂ buffer film 12;

(2) the differences in reflectance cause differences in luminance effectively since the microscope of FIG. 16 using coherent light is an confocal optical system;

(3) the reflecting light amount from the Ta radiation absorber 13 decreases since a focal shift arises for the Ta radiation absorber 13 due to a step of about 100 nm in height between the resist mask 14 and the multilayer 11; and

(4) since a focal shift arises for the portion of the SiO₂ buffer film 12 extruded outside from the bottom edge of the Ta radiation absorber 13, the reflecting light amount from this portion decreases, and the decrease is larger as the extruded length D is larger.

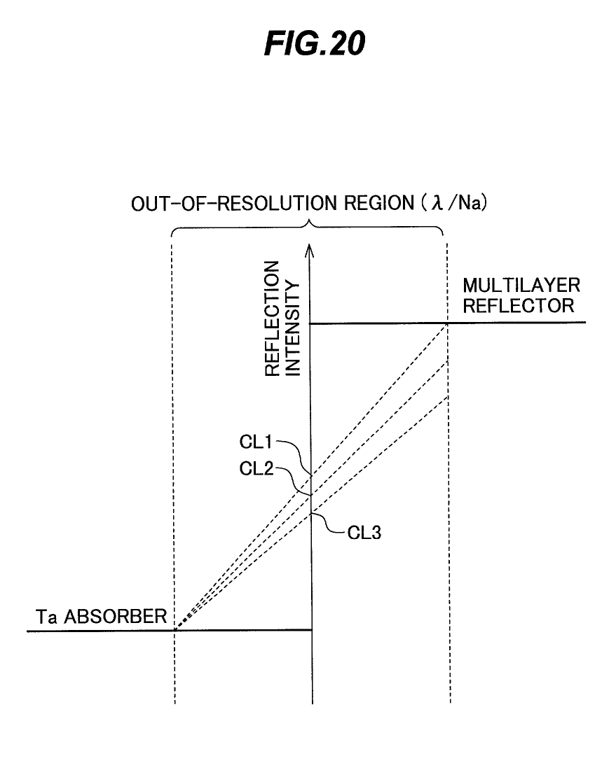

FIG. 20 is an illustration of a reflection intensity around a boundary between the Ta radiation absorber 13 and the multilayer reflector 11. Solid lines in FIG. 20 respectively indicate reflection intensities of the Ta radiation absorber 13 and the multilayer reflector 11 themselves. The resolution of the microscope of FIG. 16 is given as λ/Na, wherein λ is the wavelength of laser beam and Na is the numerical aperture of the objective lens 55.

It is well known in the art that a reflection intensity actually measured in a out-of-resolution region around the boundary between the Ta radiation absorber 13 and the multilayer reflector 11 changes continuously and that the curve thereof shows a reversed S character shape. When the extruded side portion of the SiO₂ buffer film 12 outside from the boundary exists on the multilayer reflector 11, the reflection intensity of this portion decreases, the decrease is larger as the extruded length D is longer, and a change in reflection intensity becomes more gentle as the extruded length D is longer. For these reasons, as the extruded length D is longer, the characteristic luminance CL is smaller.

Points CL1, CL2 and CL3 in FIG. 20 indicate characteristic luminance values when the extruded lengths are D1, D2 and D3, respectively, wherein relations of D1<D2<D3 and CL1>CL2>CL3 holds.

Fifth Embodiment

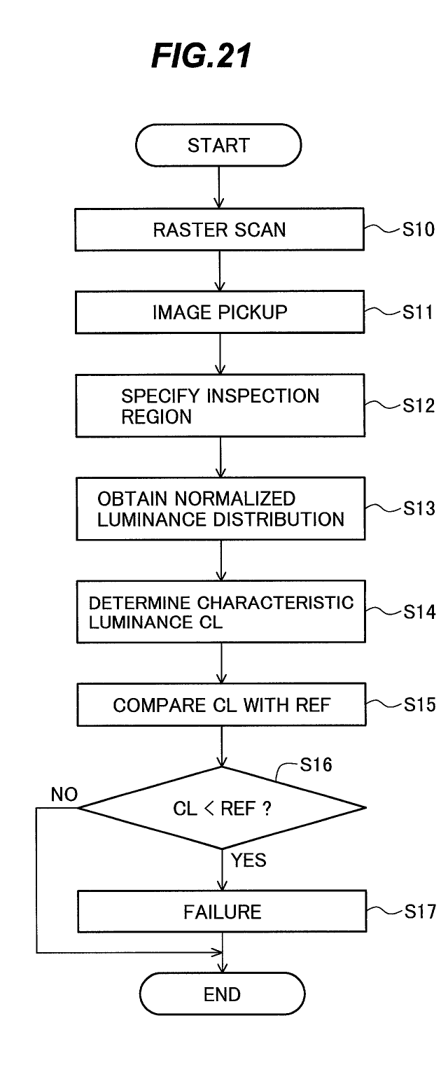

FIG. 21 is a flow chart showing a procedure for pass/failure determination of a side etching amount, of a fifth embodiment according to the present invention. The hardware configuration of a side etching amount pass/failure determining apparatus is the same as that of FIG. 16.

(S10) A reflective mask 45 is raster-scanned with laser beam.

(S11) The image processor 59 receives an image signal from the image pickup device 58 and stores the image into a memory device thereof.

(S12) An operator operates the input device 61 to specify an inspection region 72 as shown in FIG. 17.

(S13) A luminance distribution along X axis in the region 72 is obtained and the data is normalized such that the maximum luminance becomes a predetermined value, 256 for example.

(S14) The above described characteristic luminance CL is determined from the normalized luminance distribution.

(S15) The characteristic luminance CL is compared with a reference value REF.

(S16) If CL<REF, then the process goes to step S17, else the process is terminated.

(S17) A display device 60 is caused to present thereon that the reflective mask 45 is failure due to shortage of the side etching amount of the SiO₂ buffer film 12.

Although preferred embodiments of the present invention has been described, it is to be understood that the invention is not limited thereto and that various changes and modifications may be made without departing from the spirit and scope of the invention.

For example, the radiation absorber 13 may be such a heavy metal as W, PT, Au or Ge.

The multilayer reflector 11 may be such one that reflection arises for incident light on the basis of the Bragg reflection condition, and its constituents may be other pair of first and second films, the first film being of such a heavy element as Cr, Ni, Mo, Ru, Rh, W or Re, and the second film being of such a light element as Be, B, C or Si.

The substrate 10 may be another having a surface polished to such a grade that the multilayer reflector 11 has enough evenness not to inadmissibly decrease reflectance thereof.

The buffer film 12 may be grown with a CVD (chemical vapor deposition) apparatus at a temperature in the range where the multilayer reflector 11 is not broken, for example, 150° C. or lower. When the SiO₂ buffer film 12 having a different quality is grown, ammonium fluoride may be added in order to increase the rate of wet etching.

Instead of the etching endpoint determining circuit 43 of FIG. 12(A), a circuit 43A of FIG. 12(B) in which the differentiator 432 is omitted may be employed, and the etching endpoint may be determined when the relation of VIA<VS2 or VIA>VS3 has been detected, where the reference voltage VS2 is, as shown in FIG. 14, a value lower than the steady-state value of the signal VIA prior to detection of the endpoint, and the reference value VS3 is a value higher than the steady-state value. Note that the cycle time of the vibration at the endpoint in FIG. 14 is of the order of hundreds of msec.

Furthermore, the light source 41 may be disposed such that the light beam comes perpendicularly onto the substrate 30, and it may be determined that the etching endpoint is reached when a scattered light in an oblique direction is detected by the photodetector 42.

In FIG. 16, the neutral density filter 52 may not be employed, an ordinary beam splitter may be employed instead of the polarization beam splitter 53, or the ¼ wavelength plate 54 may be omitted. A microscope may have two optical systems separated from each other, one is an illumination optical system in which the mask 45 is obliquely illuminated with a light beam and the other is a reflected light imaging optical system in which reflected light from the mask 45 is directed onto the image pickup device 58 to form an image, wherein neither the polarization beam splitter 53 or the ¼ wavelength plate 54 is necessary.

What is claimed is:

1. A method of fabricating a reflective mask, comprising the steps of:
providing a blank mask, said blank mask having a buffer film interposed between a radiation absorber film and a multilayer reflector, an etch mask being formed on top of said radiation absorber film, said etch mask having a pattern corresponding to a integrated circuit pattern;
performing reactive ion overetching using a first reactive gas to remove portions of said radiation absorber film together with attaching a first deposit onto sidewalls of portions of said buffer film, said first deposit including a compound formed by reaction of a material of said radiation absorber film with said first reactive gas;
performing reactive sputter underetching using a second reactive gas to remove portions of said buffer film with leaving a residual buffer film together with attaching a second deposit on sidewalls of portions of said buffer film, said second deposit including a compound formed by reaction of a material of said buffer film with said second reactive gas; and
performing wet etching to remove portions of said residual buffer film using a reactive liquid having a higher solubility of said second deposit than that of said first deposit and to expose portions of a top layer of said multilayer reflector.

2. The method of claim 1, wherein a material of said buffer film is SiO₂.

3. The method of claim 2, wherein a material of said radiation absorber film is Ta, said first reactive gas comprises a chlorine, said first deposit comprises a chloride of Ta, said second reactive gas comprises a fluorine, said second deposit comprises a fluorinated carbon and said reactive liquid is a dilute hydrofluoric acid solution.

4. The method of claim 3, wherein in said step of performing wet etching, a time of said wet etching is a sum of a time t1 for just etching a thickness of said residual buffer film and a time t2 less than t1.

5. The method of claim 4, wherein a concentration of hydrofluoric acid in said dilute hydrofluoric acid solution is about 3.3%.

6. The method of claim 1, wherein said multilayer reflector has a structure in which a pair of Mo and a—Si films is repeatedly stacked and a top layer thereof is an a—Si film thicker than any other a—Si thereof.

7. A method of detecting a wet etching endpoint, comprising the steps of:
providing a substrate, said substrate having a hydrophilic film on a wafer repellent material;
applying an etching aqueous solution film on said hydrophilic film;
illuminating said substrate with a light beam; and
detecting said wet etching endpoint on the bases of a disturbance of reflected light from said substrate.

8. The method of claim 7, wherein in said step of illuminating, said light beam obliquely comes onto said substrate and said wet etching endpoint is determined by detecting a signal change due to vibration of a light intensity in a direction of regular reflection.

9. The method of claim 8, wherein in said step of illuminating, said wet etching endpoint is determined by detecting said light intensity as a first signal, differentiating said first signal to derive a second signal, and comparing said second signal with a reference value.

10. The method of claim 8, wherein in said step of illuminating, said wet etching endpoint is determined by detecting said light intensity as a signal, and comparing said signal with a reference value.

11. The method of claim 7, wherein in the step of providing, said water repellent material and said hydrophilic film are a top layer material of a multilayer reflector and a buffer film, respectively, of a reflective mask for extreme ultra violet lithography.

12. The method of claim 11, wherein in the step of applying, said etching aqueous solution film is formed by spraying an etching aqueous solution on said substrate with spinning said substrate.

13. A method for wet etching comprising the steps of:
providing a system, said system having a rotary table, a nozzle disposed facing to said rotary table, a light source disposed so as to obliquely irradiate a light beam onto a substrate to be mounted on said rotary table, and a photodetector disposed so as to detect a regular reflection of said light beam;
mounting a substrate on said rotary table, said substrate having a hydrophilic film on a wafer repellent material, etch mask being formed on top of said hydrophilic film;
ejecting an etching aqueous solution from said nozzle to apply onto said hydrophilic film of said substrate with rotating said rotary table;
ceasing the ejection of said etching aqueous solution and the rotation of said rotary table;
detecting reflected light from said substrate with said photodetector;
determining an etching endpoint when an output of said photodetector is disturbed; and
ejecting said etching aqueous solution from said nozzle with rotating said rotary table in response to the determination of said etching endpoint.

14. The method of claim 13, further comprising the step of:
forcing said nozzle to approach said substrate before the second ejection of said etching aqueous solution after the ceasing of the first ejection of said etching aqueous solution.

15. The method of claim 13, further comprising the step of:
ceasing the second ejection of said etching aqueous solution when a predetermined time has elapsed from the determination of said etching endpoint.

16. The method of claim 14, further comprising the step of:
ceasing the second ejection of said etching aqueous solution when a predetermined time has elapsed from the determination of said etching endpoint.

17. A wet etching endpoint detecting apparatus comprising:
a light source disposed such that a light beam therefrom obliquely irradiates a substrate to be etched;
a photodetector disposed so as to detect regularly reflected light from said substrate; and
an etching endpoint determining apparatus detecting a disturbance of an output of said photodetector to determine an etching endpoint.

18. The wet etching endpoint detecting apparatus of claim 13, wherein said etching endpoint determining apparatus determines said etching endpoint when a differential of said output of said photodetector has exceeded a reference value.

19. The wet etching endpoint detecting apparatus of claim 13, wherein said etching endpoint determining apparatus determines said etching endpoint when said output of said photodetector has become lower than a reference value.

20. An apparatus for inspecting a reflective mask, said reflective mask having a reflective substrate, a transparent film formed on said reflective substrate, and an absorptive film formed on said transparent film, both said absorptive film and said transparent film having removed portions corresponding to each other to expose a portion of said reflective substrate, comprising:
a microscope picking up a magnified image data of said reflective mask;
an image processor obtaining a luminance curve on a line extending from a portion of said absorptive film to a portion of said reflective substrate using said image data, obtaining a luminance at a point where a luminance change rate on said luminance curve is about maximum as a characteristic luminance.

21. The apparatus of claim 20, wherein said image processor determines that an extruding length of a bottom edge of a sidewall of said transparent film outside from a bottom edge of said absorptive film is longer than a maximum permissible length when said characteristic luminance is lower than a predetermined value.

22. The apparatus of claim 20, wherein said image processor determines that an extruding length of a bottom edge of a sidewall of said transparent film outside from a bottom edge of said absorptive film is longer than a maximum permissible length when a ratio of said characteristic luminance to a highest value of said luminous curve is lower than a predetermined value.

23. The apparatus of claim 20, wherein said microscope comprises:
a light source emitting a light beam;
a deflector deflecting said light beam to scan;
an image pickup device; and
an optical system condensing the deflected light onto said reflective mask, collimating reflected light from said reflective mask, and condensing the collimated light from said reflective mask onto said image pickup device to make a raster image.

24. The apparatus of claim 20, wherein said transparent film is a buffer film.

25. The apparatus of claim 20, wherein said reflective substrate comprises a multilayer reflector.

26. The apparatus of claim 20, further comprising: an input device for setting said line or a region including said line for said image processor.

27. The apparatus of claim 23, wherein said microscope further comprises: a neutral density filter attenuating said emitted light.

28. A method of inspecting a reflective mask, said reflective mask having a reflective substrate, a transparent film formed on said reflective substrate, and an absorptive film formed on said transparent film, both said absorptive film and said transparent film having removed portions corresponding to each other to expose a portion of said reflective substrate, comprising the steps of:
providing a microscope picking up a magnified image data of said reflective mask;
obtaining a luminance curve on a line extending from a portion of said absorptive film to a portion of said reflective substrate using said image data;
obtaining a luminance at a point where a luminance change rate on said luminance curve is about maximum as a characteristic luminance; and
determining whether or not an extruding length of a bottom edge of a sidewall of said transparent film outside from a bottom edge of said absorptive film is longer than a maximum permissible length on the basis of said characteristic luminance.

29. The method of claim 28, wherein in the step of determining, determining said extruding length is longer than said maximum permissible length when said characteristic luminance is lower than a predetermined value.

30. The method of claim 28, wherein in the step of determining, determining said extruding length is longer than said maximum permissible length when a ratio of said characteristic luminance to a highest value of said luminous curve is lower than a predetermined value.
